(19) United States
(12) Patent Application Publication
(10) Pub. No.: US 2009/0076632 A1
(43) Pub. Date: Mar. 19, 2009

(54) INTEGRATED RESOURCE MONITORING SYSTEM WITH INTERACTIVE LOGIC CONTROL

(75) Inventors: Mark Kram, Santa Barbara, CA (US); Hugo Loaiciga, Goleta, CA (US)

Correspondence Address: FELIX L. FISCHER, ATTORNEY AT LAW, 1607 MISSION DRIVE, SUITE 204, SOLVANG, CA, 93463, US

(73) Assignee: GROUNDSWELL TECHNOLOGIES, INC., Santa Barbara, CA (US)

(21) Appl. No.: 11/857,354

(22) Filed: Sep. 18, 2007

(51) Int. Cl. G05B 13/00

(52) U.S. Cl. 700/33

(57) ABSTRACT

A system for resource usage optimization employs an automatically controlled sensor suite providing data to a computer system for the analysis of spatial relationships of the sensors and resources. A control module incorporates an interactive logic, in an exemplary embodiment of well-stream coupled dynamic or game theory engines, operating in conjunction with the spatial data processing algorithms, GIS in an exemplary embodiment, receives as an input an objective function set for the use of the resource and constraint sets which are then monitored by the sensor suite. Incoming data is compared to the constraint sets and upon impact to any of the elements of the objective function set, creates a report/alarm for action or to trigger a corrective action.

### BACKGROUND OF THE INVENTION

1. Field of the Invention

This invention relates generally to the field of automated systems for monitoring of resource usage and particularly to a system employing an interactive logic control with objective functions and constraint sets as inputs for real time status output with warning/alarm capability.

2. Description of the Related Art

Over-pumping of ground water is becoming more and more commonplace. This is especially true in arid regions of the Southwest United States. A recent GAO report claims that 36 states will encounter severe water shortages within 5 years! U.S. Government Accountability Office, Freshwater Supply: States' Views of How Federal Agencies Could Help Them Meet the Challenges of Expected Shortages,” GA 0-03-514, July 2003, p 1)]Since many water supply well fields are installed adjacent to areas of shallow surface water, significant impairment to adjacent riparian habitat can result from ground water extraction activities. Reduction in the ground water potentiometric surface due to over-pumping can induce leakage of the surface water body, thereby reducing the total amount of flow in rivers, streams, and springs. Stream flow reduction during fish migration seasons threatens the species survival potential. The methods covered in the patent application are applicable to predicting the effects of groundwater extraction on aquifer storage in general and on seawater intrusion in coastal aquifers.

Cooperative equilibrium arises when ground water users respect environmental constraints and consider mutual impacts, which allows them to derive economic and environmental benefits from ground water indefinitely, that is, to achieve sustainability. For cooperative equilibrium to hold, however, enforcement must be effective. Otherwise, according to the Commonized Costs-Privatized Profits (or CCPP) paradox, there is a natural tendency towards non-cooperation and non-sustainable aquifer mining, of which overdraft is a typical symptom. This would be exemplified by overdraft of a water-bearing zone adjacent to a river, thereby depleting the river of volume and ecologic functionality. Non-cooperative behavior arises when at least one ground water user neglects the externalities of his adopted ground water pumping strategy. In general, non-cooperative behavior results from lack of consideration regarding the interactions between the localized surface and ground water resources due to lack of information.

There is a significant need to better understand the ecological impacts due to ground water extraction activities adjacent to rivers, streams and springs. An automated interactive monitoring and modeling system will provide watershed managers with continuous understanding of the dynamic interactions between ground water extraction activities and surface water levels, and will allow for automated establishment of maximum allowable extraction thresholds based on minimum surface water level requirements, and therefore lead to optimization of ground water extraction activities while protecting the riparian habitat.

It is therefore desirable to provide systems and methods to optimize, monitor, and manage ground water resources based on the integration of sensors with computing capability incorporating an understanding of the ground water and surface water relationships. The methods of this patent application are applicable to predicting and controlling the effects of groundwater extraction on aquifer storage in general and seawater intrusion in coastal aquifers, also.

### SUMMARY OF THE INVENTION

The present invention is a system for resource usage optimization employing an automatically controlled sensor suite providing data to a computer system for the analysis of spatial relationships of the sensors and resources. A control module incorporating an interactive logic, in an exemplary embodiment of well-stream coupled dynamic or game theory engines, operating in conjunction with the spatial data processing algorithms, GIS in an exemplary embodiment, receives as an input an objective function set for the use of the resource and constraint sets which are then monitored by the sensor suite. Incoming data is compared to the constraint sets and upon impact to any of the elements of the objective function set, creates a report/alarm for action or to trigger a corrective action.

In an enhanced embodiment, the sensor suite input data is provided to a constraint sets calculator for update of the constraint set assumptions for remodeling of interactive logic calculations. Tracking of input, output and relationships with thresholds over time is also accomplished.

As an exemplary embodiment, a system incorporating the invention is employed for well water monitoring on one or multiple wells drawn upon for either municipal or agricultural use by multiple users. The objective functions for the interactive logic modeling system allow maximizing the water withdrawal capability in the most economically efficient manner by multiple users while avoiding salt water intrusion into the well from overdraw conditions or exceeding a river water level minimum, the latter relying of coupled dynamic interaction algorithm for well-stream systems. The constraint sets preloaded into the model include response of the aquifer modeled from static data including historical permeability and storage capacity, flow rates and water table level history. The sensor suite monitors flow rate(s) and well level. In one exemplary embodiment, Game Theory employed as the interactive logic establishes the optimum flow rates for the desired economic maximization. Flow rate monitoring may be accomplished at both the withdrawal well and aquifer replenishment sources including monitoring wells surrounding the extraction well or feeding stream flow rates for update to the constraint data on flow rates, etc. Water table level (at the feed well and monitoring wells), river level, etc. data from the sensor suite is used to validate/update the constraints for the Game Theory for closed loop operation.

### BRIEF DESCRIPTION OF THE DRAWINGS

These and other features and advantages of the present invention will be better understood by reference to the following detailed description when considered in connection with the accompanying drawings wherein:

FIG. 1 is a block diagram showing the physical elements of an exemplary embodiment and its functional control elements;

FIG. 2 is a block diagram of a first exemplary implementation for impact of multiple drawdown wells on a stream;

FIG. 3 is a block diagram of a second exemplary implementation for impact of multiple drawdown wells on a ground water table;

FIG. 4 is a flow chart of the operation of the functional control elements for a disclosed embodiment; and

FIG. 5 is an example output data presentation.

### DETAILED DESCRIPTION OF THE INVENTION

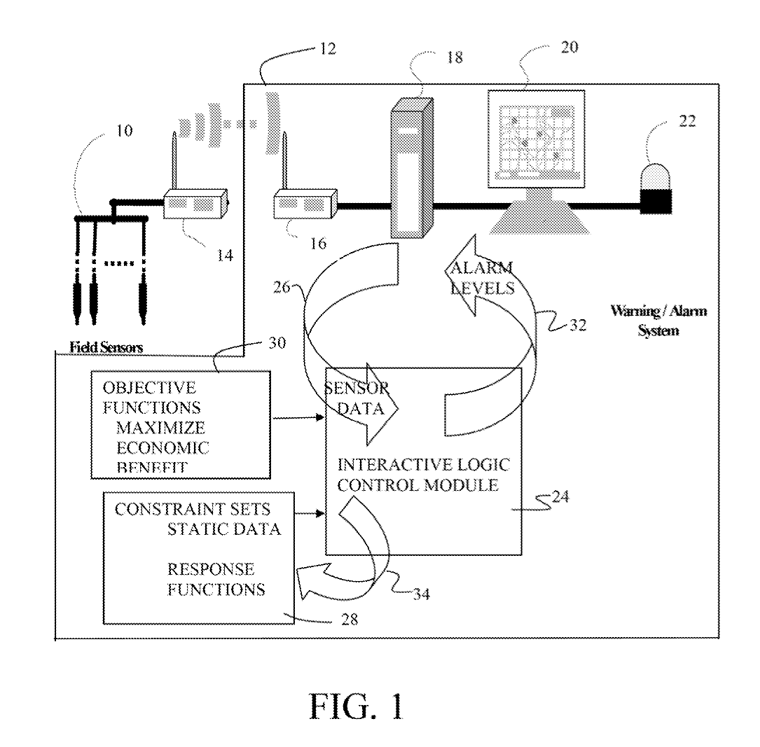

Referring to the drawings, FIG. 1 shows the elements of an embodiment of the present invention. Field sensors 10 are placed at the various physical features which are to be measured such as wells, streams or aquifers. The sensors themselves may include such devices as flow meters, temperature sensors, pH sensors, dissolved oxygen sensors and level sensors which indicate the condition of the physical feature under study. By the nature of the desired system effectiveness, multiple physical features will be monitored resulting in multiple sets of field sensors. In most cases the field sensors will be remote from the control center generally designated as 12 which houses the control and reporting elements of the system and telemetric systems such as transmitters 14 at or near each physical feature and receivers 16 residing at the location of the control center. The representation in the drawings provides for radio transmission, however, in actual embodiments telemetry transmission approaches may be of any applicable form known to those skilled in the art. Automated control of the multiple sensor suites is implemented in exemplary embodiments as disclosed in U.S. Pat. No. 6,915,211 issued on Jul. 5, 2005 entitled GIS BASED REAL-TIME MONITORING AND REPORTING SYSTEM the disclosure of which is incorporated herein by reference.

A computer 18 for processing of the telemetered sensor data is provided including integrated Geographic Information System (GIS) capability or other automated spatial data processor for calculation of geographically dependent parameters based on location of the physical features. A display 20 is provided as shown in the figure and may include multiple physical display screens or elements distributed for monitoring and decision making based on system output as will be described subsequently. In addition to the display(s) or as an integral presentation on the display(s) a warning/alarm system 22 is provided. In alternative embodiments, automatic dialing of telecommunications devices such as cell phones or pagers is also accomplished.

An interactive logic control module 24 operates on the computer receiving sensor data 26 as processed. The control module operates based on input from constraint sets 28 which may include static data and response functions measured with respect to the physical features under study. The discussion of the embodiments disclosed herein emphasizes economic benefit, but most often will be set to physical tolerances such as threshold water levels in actual physical operations. Additionally, the control module incorporates in its operation objective functions 30 predetermined by the system user. These objective functions may include such elements as maximizing the economic benefit of the overall use of the physical features as will be described in greater detail subsequently. The control module provides alarm levels 32 for activation of the warning/alarm system based on the calculations performed. Additionally, the sensor data received is provided in certain embodiments as feedback 34 to update the constraint sets.

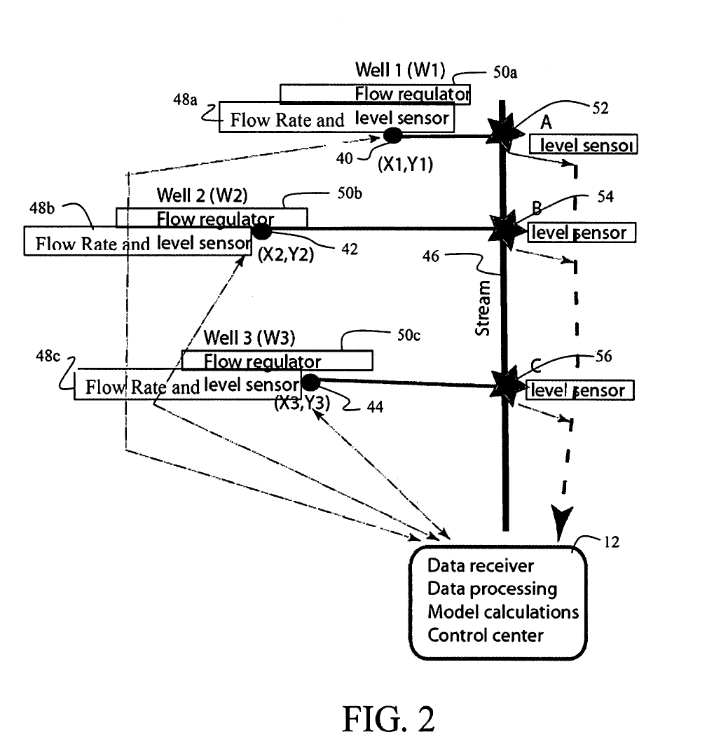

A first exemplary use of the system is demonstrated in FIG. 2 for monitoring the impact of multiple wells 40, 42 and 44 in distributed locations where drawdown on the wells may impact a nearby hydraulically connected stream 46. The system incorporates field sensors including flow rate and level sensors 48a, 48b and 48c at each of the wells. A flow regulator 50a, 50b and 50c at each well may be employed for control feedback as will be described subsequently. The system also incorporates field sensors associated with the stream including level sensors 52, 54 and 56 located along the stream length. As shown, the field sensors provide their data to the control center system 12.

The data provided for active monitoring by the field sensors and the constraint sets employed by the control module includes the locations (x, y) of the extraction wells in a geo-referenced coordinate system; stream layout in the geo-referenced coordinate system; transmissivity and storativity associated with the stream, wells and intervening geological formations; total streamflow at a given time (tracked via level monitoring), current water depth, temperature provided by the associated field sensors; channel and overbanks' roughness; stream cross section and longitudinal profile in the reach affected by the wells; pumping well characteristics; historical pumping rates; and immediate flow rates of the wells.

Objective functions input to the control module may include such elements stream depletion regulations as limitations to assure that the stream level remains above a safe threshold (habitat sustainability) during ground water extraction by the wells under study. The data collected is applicable for use in determining current use limitations and future expansion potential.

The control module calculates the fraction of each well's pumping rate drawn from the stream and calculates the total volume of streamflow draft from the multiple wells simultaneously. Based on the constraint data, the system then estimates maximum pumping rate(s) allowed given permissible streamflow depletion. This constraint data may be obtained through trial-and-error with multiple outputs possible from the control module. In an exemplary application, the system compares extraction rates to optimal rates and provides a data output.

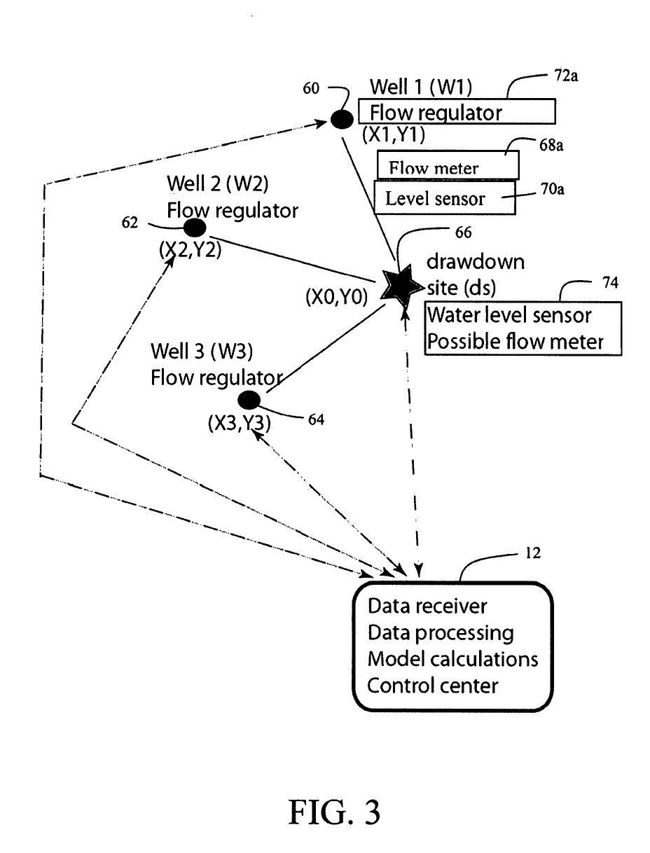

A second exemplary use of the system is shown in FIG. 3 wherein multiple wells 60, 62 and 64 interact through a common aquifer. The aquifer properties are measured at draw down site 66 which may employ a monitoring well. As in the prior example, each well incorporates a field sensor set that includes at least a level sensor 68a, 68b and 68c and flow meter 70a, 70b and 70c which may be a pumping rate monitor. A flow regulator 72a, 72b and 72c is employed for control feedback. The monitoring well at the draw down site employs a field sensor set that includes a level sensor 74 and may include a flow meter with flow direction sensing in certain advanced embodiments. In alternative embodiments, when using the invention to protect from saltwater intrusion water level sensors are placed in several wells to determine the direction of flow near the salt-fresh water interface. If direction of flow is opposite to what is desired, this can serve as the tolerance modeled to in order to determine pumping logistics. The data from the field sensors is provided to the control center.

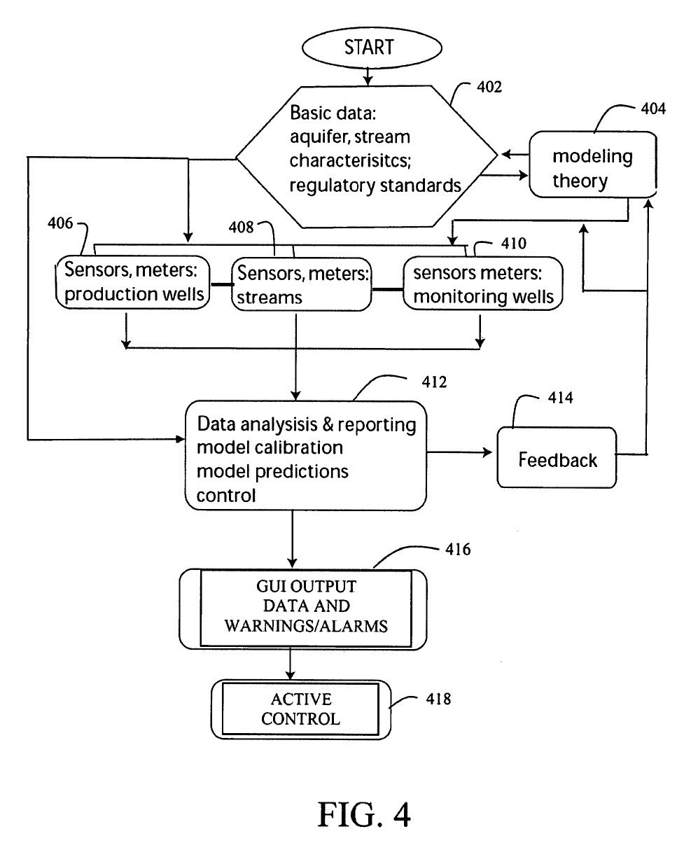

FIG. 4 shows basic elements of data flow for the exemplary embodiments of the invention presented herein. Basic data 402 for aquifer and stream characteristics as well as regulatory and protection or threshold requirements are entered as constraint sets and objective functions. This basic data is exchanged interactively with the modeling theory 404 employed in the interactive logic control module. Field sensors and other measurement sources from production wells, streams and monitoring wells respectively provide input data 406, 408 and 410 to the interactive logic control module for data analysis and reporting, model calibration, model predictions and control 412. Feedback 414 is provided to update the modeling theory. Sensor data is entered into the model along with pre-measured values to determine amount of drawdown associated with each pumping well, then impact on the specific location (e.g., amount of water level reduction) is determined, upon which the data is plotted (e.g., as extraction rate versus sustainable extraction rate for that time step for each well). If a threshold is exceeded, this is displayed graphically and could be (but does not always have to be) integrated with a control module to reduce the extraction rate at a particular well that is pumping at an unsustainable rate. The output provided by the data analysis and reporting function is presented 416 for management decisions and recommendations including warning/alarms attributable to excess drawdown based on the constraint sets, objective functions and modeling theory. Active control 418 is implemented in advanced embodiments for automatic control of pumping rates or other affirmative output to well operators for required action. This could be in the form of automated e-mail advisories/directives or similar communications or automated reduction in pumping rates.

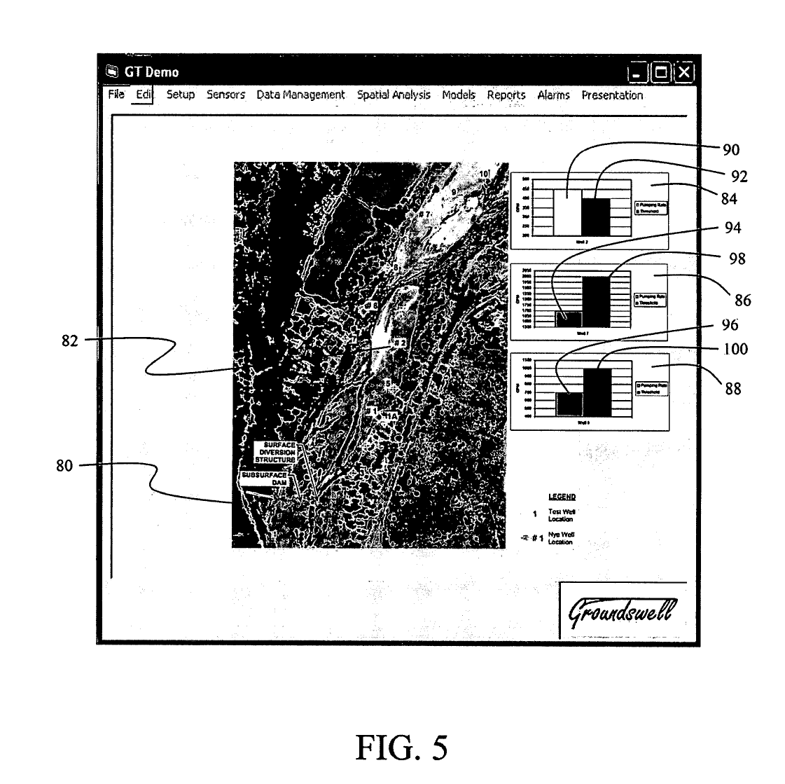

Output is provided through a Graphical User Interface (GUI) on display 20 and incorporates a format such as that shown in FIG. 5 for the exemplary embodiments. A general digital map overview such as that available in GIS systems of the aquifer/well or well/stream system 80 is provided showing the location and physical relationship of the various elements such as wells 82. Graphical data presentations 84, 86 and 88 determined by the data analysis and reporting function are provided for each element, i.e. for each well. In the example shown, well 2 is exceeding its sustainable threshold with pumping rate 90 compared to modeled limitation 92 with warning/alarm functionality shown in, for example, a distinctive color such as yellow or red. Wells 7 and 8 have pumping rates 94 and 96, respectively, which are within their modeled limitations or sustainable values 98 and 100.

Alternative embodiments include additional decision support quality information integrated with controllers to automatically respond to conditions. For instance, if a groundwater extraction rate is deemed unsustainable based on model feedback, automatic the reduction in extraction rates is accomplished through a supervisory control and data acquisition (SCADA) system.

In one exemplary embodiment for the interactive control logic, an algorithm based on Game Theory such as that disclosed by Nash, J. F., 1950. Equilibrium points in n-person games. Proceedings of the National Academy of Sciences of the U.S.A., 36, 48-49 and Nash, J. F., 1951 Non-cooperative games. Annals of Mathematics, 54, 286-295, is employed to derive modeling strategies that would provide sustainability. General application of game theory is employed for competitive activities (games) in which each participating party chooses an individual strategy that affects all the other parties taking part in the game. The participants can be non-cooperative or cooperative. In a non-cooperative scenario each party chooses strategy which is best for itself, without regards to societal or someone else's welfare. In a cooperative scenario parties may act in unison to improve their joint payoffs.

As employed with respect to embodiments of the present system, non-cooperative usage is exemplified by overdraft of a water-bearing zone adjacent to a river, thereby depleting the river of volume and ecologic functionality. This scenario arises when at least one ground water user neglects the externalities of his adopted ground water pumping strategy. In general, non-cooperative behavior results from lack of consideration regarding the interactions between the localized surface and ground water resources due to lack of information. The embodiments disclosed herein specifically make information available which may eliminate non-cooperative operation.

For a cooperative scenario, equilibrium arises when ground water users respect environmental constraints and consider mutual impacts. This allows users to derive economic and environmental benefits from ground water and habitat indefinitely—sustainability. To obtain this result, information and an adaptive approach based on dynamic data tracking is required and can be supplied by the system disclosed herein.

More specifically, when aquifer properties and extraction well characteristics are known, the algorithm can be used to estimate the water level, or potentiometric surface, at any location within the domain of an investigation. This powerful concept allows a determination of pumping thresholds for single and multi-well extraction systems in order to maintain target water levels within a natural water-bearing system. A partial list of applications includes: stream and river stage protection, cooperative ground water extraction strategy development, and protection from seawater intrusion.

The objective functions are selected for the system based on cooperative and non-cooperative parameters and may, for example, be defined to maximize economic benefit to the well operators while maintaining sustainability of the aquifer or riparian system being monitored.

Applying game theory as the interactive logic control module modeling approach for n wells (n is an integer equal to or larger than 1) each extracting groundwater at a rate Qk, k=1, 2, 3, . . . , n. The quadratic linearly constrained game-theory formulation of groundwater extraction control results in a problem of the form:

Maximize Q^{T}GQ+Q^{T}z+c

w.r. t. Q

subject to: BQ<=b

in which Q is a vector of pumping rates, T denotes “transpose”, G is a matrix of optimizing coefficients, z is a vector of aquifer data values, and c is a scalar that depends on aquifer conditions. B is matrix of constraints, and b is a vector of regulatory values imposed on drawdowns.

This problem is solved for the vector of pumping rates Q, which comply with restrictions to be met at an impact location such as another well in an aquifer or a hydraulically connected stream as provided in the exemplary embodiments discussed above. Qk is then determined for each well by solving the quadratic problem state above . For the exemplary output defined in FIG. 5, this calculated Qk is presented as the modeled limitation for each well while measured actual flow rates provide the comparison data as described. In the case of well-stream interaction, the algorithm to predict stream depletion is based on an analytical solution of the radial flow equation with a stream acting as a head-boundary condition

Having now described the invention in detail as required by the patent statutes, those skilled in the art will recognize modifications and substitutions to the specific embodiments disclosed herein. Such modifications are within the scope and intent of the present invention as defined in the following claims.

What is claimed is:

1. A real-time automated system for resource usage optimization comprises:
a plurality of automatically controlled sensor suites;
a computer system having
spatial data processing algorithms;
a control module incorporating an interactive logic, operating in conjunction with the spatial data processing algorithms and receiving as an input an objective function set for the use of the resource and constraint sets;
means for receiving data monitored by the sensor suites;
means comparing the received data to the constraint sets and,
means for creating a report/alarm for action upon impact to any of the elements of the objective function set.

2. The real-time automated system for resource usage optimization as defined in claim 1 wherein each of the plurality of sensor suites has a plurality of sensors each monitoring data for a constraint.

3. The real-time automated system for resource usage optimization as defined in claim 2 further comprising means for providing the sensor suite input data to a constraint sets calculator for update of the constraint set assumptions for remodeling of interactive logic calculations.

4. The real-time automated system for resource usage optimization as defined in claim 2 wherein the interactive logic comprises game theory.

5. A real-time automated system for resource usage optimization for well water monitoring on multiple extraction wells drawn upon for use by multiple users comprising:
a plurality of automatically controlled sensor suites monitoring flow rates and levels of the extraction wells and aquifer replenishment sources including at least one monitoring well proximate the extraction wells;
a computer system having
GIS data processing algorithms;
a control module incorporating an interactive logic, operating in conjunction with the GIS data processing algorithms and receiving as an input an objective function set for the use of the resource and constraint sets, the objective functions for the interactive logic allowing maximizing the water withdrawal capability in the most economically efficient manner by multiple users while avoiding salt water intrusion into a well from overdraw conditions and the constraint sets include response of the aquifer modeled from static data including historical permeability and storage capacity, flow rates and water table level history;
means for receiving data monitored by the sensor suites;
means comparing the received data to the constraint sets and,
means for creating a report/alarm for action upon impact to any of the elements of the objective function set.

6. The real-time automated system for resource usage optimization for well water monitoring as defined in claim 5 wherein game theory is employed as the interactive logic to establish the optimum flow rates for the desired economic maximization.

7. The real-time automated system for resource usage optimization for well water monitoring as defined in claim 6 wherein flow rate monitoring accomplished at both the withdrawal well is employed to validate/update the constraints for the Game Theory for closed loop operation.

8. The real-time automated system for resource usage optimization for well water monitoring as defined in claim 5 further comprising means for automatic adjustment of pumping rates based on model output where the impact to an element of the objective function set is exceeding a predetermined threshold.

9. A real-time system automated for resource usage optimization for assuring a river water level minimum associated with multiple extraction wells drawn upon for use by multiple users comprising:
a plurality of automatically controlled sensor suites monitoring flow rates and levels of the extraction wells and river water level;
a computer system having
spatial data processing algorithms;
a control module incorporating an interactive logic, operating in conjunction with the spatial data processing algorithms and receiving as an input an objective function set for the use of the resource and constraint sets, the objective functions for the interactive logic allowing maximizing the water withdrawal capability in the most economically efficient manner by multiple users while avoiding reduction of river water level below a predetermined minimum from overdraw conditions and the constraint sets include response of the river flow modeled from static data including historical permeability and storage capacity, flow rates and water table level history;
means for receiving data monitored by the sensor suites;
means comparing the received data to the constraint sets;
means for creating a report/alarm for action upon impact to any of the elements of the objective function set; and.
means for automatic adjustment of pumping rates based on model output and whether thresholds have been exceeded.

10. The real-time automated system for resource usage optimization for assuring river level as defined in claim 9 wherein a radial flow equation with constant head boundary condition is employed as the interactive logic to establish the optimum flow rates for the desired economic maximization.

11. The real-time automated system for resource usage optimization for assuring river level as defined in claim 10 wherein flow rate monitoring accomplished at the withdrawal well and level monitoring at of the river is employed to validate/update the constraints for the radial flow equation with constant head boundary condition is solved for closed loop operation.

12. A method for real-time automated resource usage optimization comprises:
providing a plurality of automatically controlled sensor suites;
providing a computer system having
spatial data processing algorithms;
a control module incorporating an interactive logic,
operating the control module in conjunction with the spatial data processing algorithms;
receiving as an input an objective function set for the use of the resource and constraint sets;
receiving data monitored by the sensor suites;
comparing the received data to the constraint sets and,
creating a report/alarm for action upon impact to any of the elements of the objective function set.

13. The method of claim 12 further comprising the step of
providing the sensor suite input data to a constraint sets calculator;
updating the constraint set assumptions; and
remodeling interactive logic calculations.

14. The method of claim 13 wherein the interactive logic comprises game theory and the step of updating the constraint set assumptions comprises the steps of:
maximizing QT G Q+QT z+c with respect to Q subject to: BQ<=b where Q, T, G, Z, b, B were defined above;
defining flow rate for each well.
